(19) United States
(12) Patent Application Publication
(10) Pub. No.: US 2011/0082056 A1
(43) Pub. Date: Apr. 7, 2011

(54) ARRAY APPARATUS FOR DIVIDING SINGLE CELL

(75) Inventors: Jeong Won PARK, Daejeon (KR); Moon Youn JUNG, Daejeon (KR); Seon Hee PARK, Daejeon (KR)

(73) Assignee: Eletronics and Telecommunications Research Institute, Daejeon (KR)

(21) Appl. No.: 12/860,768

(22) Filed: Aug. 20, 2010

(30) Foreign Application Priority Data
Oct. 6, 2009 (KR) 10-2009-0094748

(51) Int. Cl. C40B 60/00

(52) U.S. Cl. 506/33

(57) ABSTRACT

An array apparatus for dividing a single cell includes: a fluid channel having one or more spaces for separating a single cell included in a fluid; an air valve channel positioned at an upper portion of an entrance and exit of the spaces formed in the fluid channel and controlling a fluid flow in the fluid channel; a pressure channel positioned at upper portions of the spaces formed in the fluid channel and dividing the single cell separated from the spaces; and a cell trapping structure installed in the interior of the spaces formed in the fluid channel and separating a single cell included in the fluid flowing along the fluid channel.

### CROSS-REFERENCE TO RELATED APPLICATIONS

This application claims the priority of Korean Patent Application No. 10-2009-0094748 filed on Oct. 6, 2009, in the Korean Intellectual Property Office, the disclosure of which is incorporated herein by reference.

### BACKGROUND OF THE INVENTION

1. Field of the Invention

The present invention relates to an array apparatus for dividing a single cell and, more particularly, to an array apparatus for dividing a single cell, which has been separated by using a cell trapping structure, by using an air valve channel and a pressure channel; to thus easily shift the divided single cell to a different system and process the same.

2. Description of the Related Art

Nanobiotechnology (NBT), a next-generation convergence technology, is gaining its importance as a technology that may help to create remarkable progress toward the diagnosis and treatment of human diseases.

In particular, a biochip, one of the typical sectors of biotechnology, is a bio-information detection element in which bio-materials such as DNA, proteins, antibodies, or cells are highly integrated on a solid base such as glass, silicon, polymer, and the like, which is suitable for analyzing a very small amount of a test sample very quickly.

The bio-chip may be classified into a microarray and a microfluidic chips. The microarray is a chip in which thousands or tens of thousands of strands of DNA, proteins, carbohydrates, peptides, and the like, are arranged at certain intervals, and an analysis target material is processed therewith to analyze its combination aspect, while the microfluidic chip for lab-on-a chip) is a chip used for analyzing a reaction with various biomolecules or a sensor while a very small amount of analysis target material is given in driblets.

However, the related art biochips are configured in such a manner that, in order to analyze a bio-material, a single cell is separated through an array, and in this state, the single cell is then cultivated or pharmacologically stimulated. This method causes inconvenience in that there is no method of easily shifting or moving the separated single cell to a different cultivation system. Also, because the separated single cell is directly processed on the array, the survival rate and utilization of separated single cells deteriorates.

### SUMMARY OF THE INVENTION

An aspect of the present invention provides an array apparatus for dividing a single cell, which has been separated by using a cell trapping structure, by using an air valve channel and a pressure channel, to thus easily move the divided single cell to a different system and process the same.

According to an aspect of the present invention, there is provided an array apparatus for dividing a single cell, including: a fluid channel having one or more spaces for separating a single cell included in a fluid; an air valve channel positioned at an upper portion of an entrance and exit of the spaces formed in the fluid channel and controlling a fluid flow in the fluid channel; a pressure channel positioned at upper portions of the spaces formed in the fluid channel and dividing the single cell separated from the spaces; and a cell trapping structure installed in the interior of the spaces formed in the fluid channel and separating a single cell included in the fluid flowing along the fluid channel.

One or more of the fluid channel, the air valve channel, and the pressure channel may be branched into one or more sub-channels.

The direction of the fluid channel and the directions of the air valve channel and the pressure channel may be perpendicular to each other.

The cell trapping structure may have a gap with a width smaller than the size of a single cell at a central portion of the cell trapping structure so as to allow the single cell included in the fluid to be caught at the gap.

The array apparatus for dividing a single cell may further include: a first polymer film positioned at a lower portion of the fluid channel; and a second polymer film positioned between the air valve channel and the pressure channel and the fluid channel.

A cell dividing cutout portion may be formed at a portion of the first polymer film where the entrance of the gap of the cell trapping structure is positioned.

When pressure is applied to the cell dividing cutout portion, the cell dividing cutout portion is open to allow the single cell caught at the gap of the cell trapping structure to be divided to the downside through the cell dividing cutout portion.

The second polymer film may expand or contract according to a change in the pneumatic pressure within the air valve channel and the pressure channel so as to open or close the fluid channel or apply pressure to the first polymer film.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an overall schematic view of an array apparatus for dividing a single cell according to an exemplary embodiment of the present invention;

FIGS. 2A and 2B are an enlarged perspective view and an exploded perspective view of a unit cell of the array apparatus for dividing a single cell according to an exemplary embodiment of the present invention;

FIG. 3 is an enlarged sectional view of the unit cell of the array apparatus for dividing a single cell according to an exemplary embodiment of the present invention; and

FIG. 4 illustrates the process of dividing a single cell by using the array apparatus for dividing a single cell according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

It will be understood that when an element is referred to as being “connected with” another element, it can be directly connected with the other element or intervening elements may also be present. In contrast, when an element is referred to as being “directly connected with” another element, there are no intervening elements present. In addition, unless explicitly described to the contrary, the word “comprise” and variations such as “comprises” or “comprising,” will be understood to imply the inclusion of stated elements but not the exclusion of any other elements.

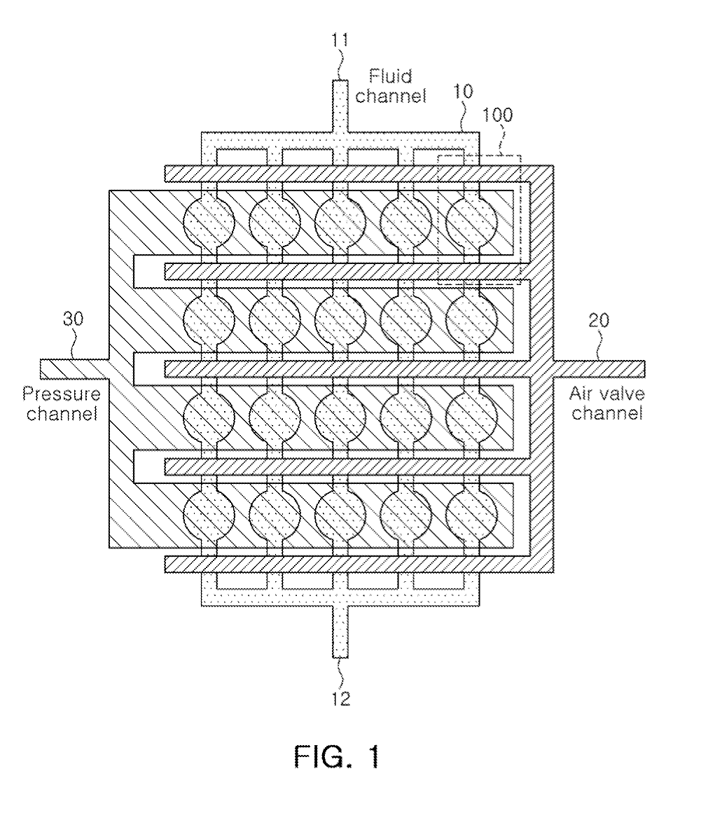

FIG. 1 is an overall schematic view of an array apparatus for dividing a single cell according to an exemplary embodiment of the present invention.

With reference to FIG. 1, the array apparatus for dividing a single cell according to an exemplary embodiment of the present invention includes a fluid channel 10, an air valve channel 20, and a pressure channel 30.

The fluid channel 10 is a channel in which a fluid containing a single cell flows. The fluid injected through a fluid entrance 11 passes through the fluid channel 10 and is discharged through a fluid exit 12.

As shown in FIG. 1, the fluid channel 10 may be branched into one or more sub-fluid channels, and each of the sub-fluid channels includes one or more spaces in which a cell trapping structure (not shown) for separating the single cell included in the fluid can be installed. FIG. 1 shows an example in which four rounded spaces are formed in each sub-fluid channel.

The air valve channel 20 and the pressure channel 30 are formed at an upper portion of the fluid channel 10, and in this case, preferably, the direction of the fluid channel 10 is perpendicular to the directions of the air valve channel 20 and the pressure channel 30.

In detail, the air valve channel 20 and the pressure channel 30 are branched into one or more sub-air valve channels and sub-pressure channels. The sub-air valve channels and the sub-pressure channels are alternately disposed one by one at the upper portion of the fluid channel 10. Thus, the sub-pressure channels are positioned at the upper portion of the space where the cell trapping structure formed at each of the sub-fluid channels is installed, and the sub-air valve channels are positioned at the entrance and the exit through which the fluid is introduced into or discharged from the spaces. The operation of dividing the single cell can therefore be controlled by using the air valve channel 20 and the pressure channel 30.

Here, the space where the cell trapping structure formed at the sub-fluid channel is installed, the sub-pressure channel positioned at the upper portion of the space, and the sub-air valve channels disposed at both sides of the sub-pressure channel constitute a single unit cell 100, and a single cell is separated from each unit cell 100 and then divided.

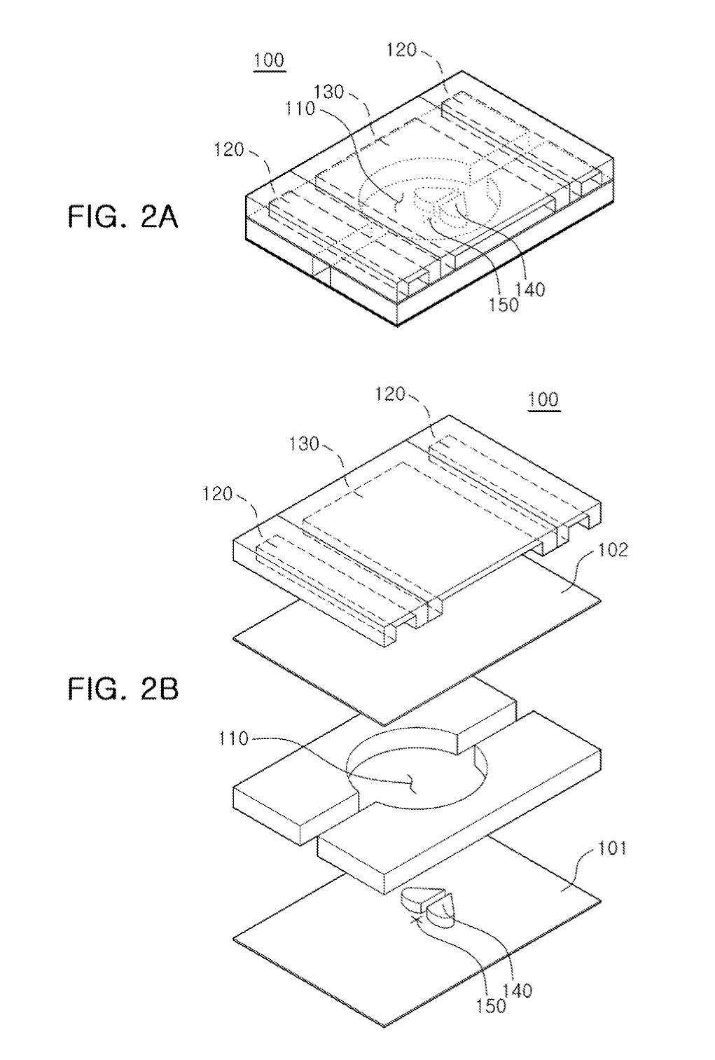

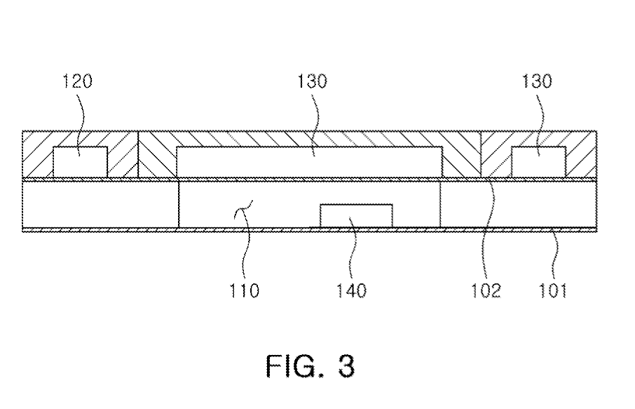

The structure of the unit cell of the array apparatus for dividing a single cell according to an exemplary embodiment of the present invention will now be described in detail with reference to FIGS. 2A, 2B and 3.

FIGS. 2A and 2B are an enlarged perspective view and an exploded perspective view of a unit cell of the array apparatus for dividing a single cell according to an exemplary embodiment of the present invention, and FIG. 3 is an enlarged sectional view of the unit cell of the array apparatus for dividing a single cell according to an exemplary embodiment of the present invention.

The unit cell 100 of the array apparatus for dividing a single cell according to an exemplary embodiment of the present invention includes a sub-fluid channel 110, sub-air valve channels 120 and sub-pressure channel 130 positioned at the upper portion of the sub-fluid channel 110, cell trapping structure 140 formed in the space formed at the sub-fluid channel 110, and polymer films 101 and 102.

The sub-fluid channel 110 is a passage allowing the fluid containing cells to flow therethrough and includes a circular space formed therein where the cell trapping structure 140 is installed.

The sub-pressure channel 130 is positioned at the upper side of the space formed at the sub-fluid channel 110 and divides the single cell separated by the cell trapping structure 140.

The sub-air valve channels 120 are positioned at both sides of the sub-pressure channel 130 and adjust an inflow and outflow of the fluid to the space formed at the sub-fluid channel 110. The sub-air valve channels 120 adjust the flow of the fluid by opening and shutting the sub-fluid channel 110 according to pneumatic pressure within the sub-air valve channel 120.

The cell trapping structure 140 is installed at the inner side of the space formed at the sub-fluid channel 110 and separates the single cell included in the fluid flowing through the sub-fluid channel 110. As shown in FIG. 2, the cell trapping structure 140 includes a gap with a width smaller than the size of the single cell so as to allow the single cell included in the fluid to be caught at the gap of the cell trapping structure 140.

The flexible polymer films 101 and 102 are positioned under the sub-fluid channel 110 and between the sub-air valve channels 120 and the sub-pressure channel 130 and the sub-fluid channel 110.

A cross type cell dividing cutout portion 150 is formed at a portion near the entrance of the gap of the cell trapping structure 140. Thus, after the single cell is separated by the cell trapping structure 140, when the polymer film 101 is pressed by the sub-pressure channel 130, the cell dividing cutout portion 150 becomes open and the single cell caught at the gap of the cell trapping structure 140 is divided to the downside through the open cell dividing cutout portion 150. Meanwhile, the cell dividing cutout portion 150 is closed when no pressure is applied thereto, thereby keeping the fluid or the cell from being leaked therethrough.

The polymer film 102 between the sub-air valve channel 120 and the sub-pressure channel 130 and the sub-fluid channel 110 expands and contracts according to pneumatic pressure within the sub-air valve channels 120 and the sub-pressure channel 130 to adjust the flow of the fluid within the sub-fluid channel 110 or divides the single cell separated by the cell trapping structure 140.

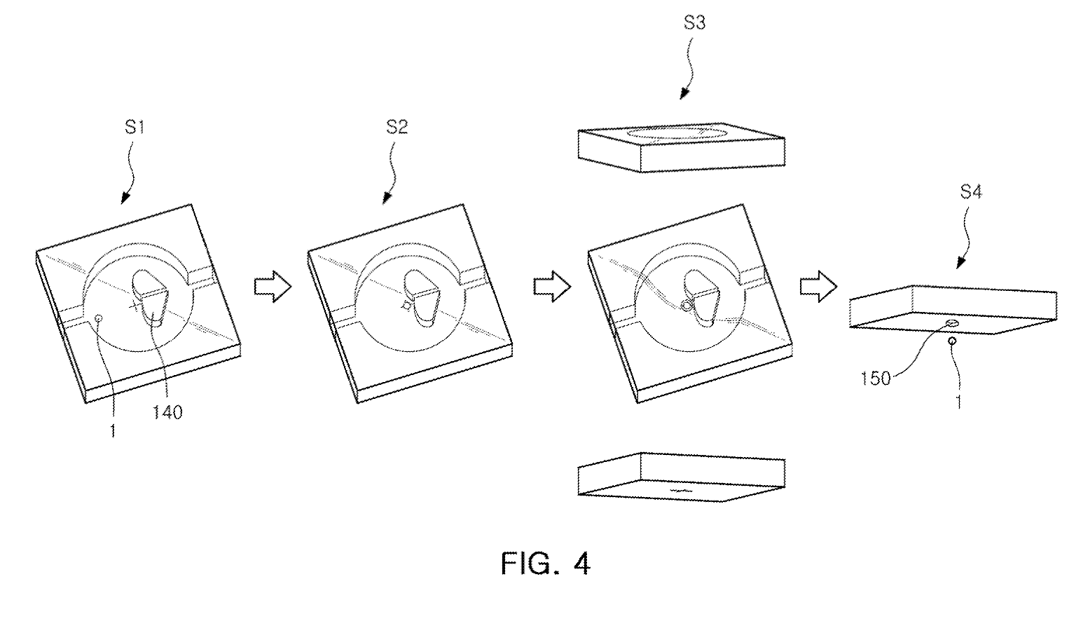

FIG. 4 illustrates the process of dividing a single cell by using the array apparatus for dividing a single cell according to an exemplary embodiment of the present invention.

Once the fluid containing single cells is injected to the fluid channel 10 and flows in the space formed within the sub-fluid channel (S1), the single cell 1 is caught at the gap of the cell trapping structure 140 (S2) and the other single cells included in the fluid bypass the cell trapping structure 140 to flow to a next unit cell.

In a state in which the single cell is separated by the cell trapping structure 140, first, air is injected into the sub-air valve channel to increase pneumatic pressure within the air valve channel to allow the polymer film under the sub-air valve channel to expand downward. Accordingly, the entrance and exit of the space formed in the fluid channel are shut, thereby preventing the fluid from flowing. Thereafter, air is injected into the sub-pressure channel to increase pneumatic pressure within the pressure channel and allow the polymer film under the sub-pressure channel to expand downward (S3). Accordingly, the polymer film under the sub-fluid channel is pressed to open the cell dividing cutout portion 150 and the single cell 1 is divided to the downside (S4).

As set forth above, according to exemplary embodiments of the invention, a single cell separated through the array apparatus can be easily moved to a different system. Thus, because the separated single cell is moved to an environment suitable for the existence or survival of the cell, a survival rate of the single cell can increase. Also, because the separated single cell is moved to and processed in a suitable system as necessary, the utilization of the single cell can be improved.

While the present invention has been shown and described in connection with the exemplary embodiments, it will be apparent to those skilled in the art that modifications and variations can be made without departing from the spirit and scope of the invention as defined by the appended claims.

What is claimed is:

1. An array apparatus for dividing a single cell, the apparatus comprising:
a fluid channel having one or more spaces for separating a single cell included in a fluid;
an air valve channel positioned at an upper portion of an entrance and exit of the spaces formed in the fluid channel and controlling a fluid flow in the fluid channel;
a pressure channel positioned at an upper portion of the spaces formed in the fluid channel and dividing the single cell separated from the spaces; and
a cell trapping structure installed in the interior of the spaces formed in the fluid channel and separating a single cell included in the fluid flowing along the fluid channel.

2. The apparatus of claim 1, wherein one or more of the fluid channel, the air valve channel, and the pressure channel is branched into one or more sub-channels.

3. The apparatus of claim 1, wherein the direction of the fluid channel and the directions of the air valve channel and the pressure channel are perpendicular to each other.

4. The apparatus of claim 1, wherein the cell trapping structure has a gap with a width smaller than the size of a single cell at a central portion of the cell trapping structure so as to allow the single cell included in the fluid to be caught at the gap.

5. The apparatus of claim 4, further comprising:
a first polymer film positioned at a lower portion of the fluid channel; and
a second polymer film positioned between the air valve channel and the pressure channel and the fluid channel.

6. The apparatus of claim 5, wherein a cell dividing cutout portion is formed at a portion of the first polymer film where the entrance of the gap of the cell trapping structure is positioned.

7. The apparatus of claim 6, wherein when pressure is applied to the cell dividing cutout portion, the cell dividing cutout portion is open to allow the single cell caught at the gap of the cell trapping structure to be divided to the downside through the cell dividing cutout portion.

8. The apparatus of claim 5, wherein the second polymer film expands or contracts according to a change in the pneumatic pressure within the air valve channel and the pressure channel so as to open or close the fluid channel, or apply pressure to the first polymer film.
